(19) United States
(12) Patent Application Publication
(10) Pub. No.: US 2003/0016523 A1
(43) Pub. Date: Jan. 23, 2003

(54) Dual lampshade system with motion effects

(76) Inventor: Timothy James Pickens, Tampa, FL (US)

Correspondence Address: Timothy James Pickens, 1017 Sylvia Lane, Tampa, FL, 33613, US

(21) Appl. No.: 10/192,983

(22) Filed: Jul. 11, 2002

Related U.S. Application Data
(60) Provisional application No. 60/306,948, filed on Jul. 20, 2001.

(51) Int. Cl. F21V 21/30

(52) U.S. Cl. 362/35; 362/356; 362/806

(57) ABSTRACT

A decorative display device comprising an electrically energized lamp, a pair of concentric lampshades surrounding the light bulb. The pair of concentric lampshades are configured so as to create a continuous airspace between the inner and outer lampshades. The outer lampshade has one or more apertures at predetermined locations, the apertures being shaped for a desired design. The outer lampshade has pictorial representation representing a predetermined theme. Inner lampshade pictorial representations are located so as to be viewable through the apertures in the outer lampshade. The inner or outer lampshades are configured with support arms to rotate relative to each other. Caricatures can be supported on arms and located in between the inner and outer lampshades for rotation therebetween to enhance the desired theme. The caricatures can also be made to oscillate up and down.

This invention is related to the field of decorative lamps and lampshades; more specifically, to table lamps and lampshades that create depth, motion, and lighting effects using three dimensional techniques or devices.

The desire to produce visually pleasing and artistic lampshades that incorporate depth, light effects, and motion, are well documented in prior art. Lampshades, which incorporate viewing apertures and secondary layers of shade material, are known in the industry. Two of those are disclosed in U.S. Pat. No. 2,974,435 to Eschenroeder and U.S. Pat. No. 3,456,106 to Gluschkin. They show a lampshade design that laminates inner and outer layers of shade material in the same general conical shape, and a viewing aperture for use with photographs or images. While these designs have a unique light and visual effect, they lack any depth or air space between the layers of shade material that would create a three-dimensional medium for a wider range of artistic expression.

U.S. Pat. No. 4,817,315 issued to Kammerer on Apr. 4, 1989 discloses a single frustoconical lampshade with a series of two dimensional, frustoconical transparent and translucent inner frames with pre-distorted pictorial representations. The inner transparent and translucent frames are shaped frustoconical and aligned behind each other inside the lampshade and viewed through its single aperture. The lampshade is a typical frustoconical lampshade with a bulb type clip. The viewing aperture is covered or obstructed by a transparent sheet of art attached on the backside of the aperture and shade. The inner frames with pictorial representations are attached to inside a vertical portion of the framed outer shade, therefore semi-concentric, and are not framed and provide no structural support. Kammerer's invention has disadvantages that limit its success in the market place. First, the design is intended for images using a series of transparent and translucent images. It does not anticipate the desire and need for simple geometric light effects such as star or diamond shapes or a clear, unobstructed viewing aperture. Secondly, the design is restricted to frustoconical lampshades and cannot be used with shades other than frustoconical, such as four sided or multi-sided shades. Third, the inventions' inner frames of art are not structured or supported well and would appear irregular or incomplete because of the unframed inner sheets of art.. Fourth, the invention does not anticipate the artistic and marketing advantages of having all 360 degrees of viewing advantage, but rather incorporates a single viewing aperture for viewing images. Finally, Kammerer's invention lacks, or fails to describe, a continuous air space between the two shades therein preventing the incorporation of motion effects as contemplated by the present invention.

Prior art lamps having rotatable features include the lamp disclosed in U.S. Pat. No. 6,135,603 to Chen and in U.S. Pat. No. 4,827,382 to Feliks. The former is a lamp that uses candles to generate heat while the latter is a small tree ornament where a light bulb generates heat sufficient to activate the rotating feature. In both cases, special fins are needed to maintain the rotation. In addition, the use of lighted candles can be hazardous, especially if the lamp is used as a table lamp in a child's room.

The present invention provides for a full double lampshade, which has 360 degrees of three dimensional depth and light effects. It can be used with lampshade shapes other than typical frustoconical shape and can be easily adapted for motion effects between the two shades. In addition, two framed lampshades provide more structural support with less tooling required in the manufacturing process. Additional advantages of my invention will become evident upon further examination of the drawings and ensuing description.

The invention is basically two complete lampshades of different sizes but similar configuration joined together and mounted on a conventional lamp with a horizontal base and a vertical post. These are commonly referred to as table lamps. The combination of the smaller inner shade and larger outer shade gives artists and designers a medium with new, surprising artistic possibilities. The inner shade, preferably centered inside the larger outer shade, is the primary shade that diffuses and re-directs light from a typical 40 to 75 watt bulb. As a result, secondary visual effects from several viewing angles become evident when looking at the larger outer shade. First, the outer shade creates a three dimensional depth effect by contrasting with the smaller inner shade, especially when viewing apertures are added. Secondly, it creates light effects from the contrasting glow of the inner shade that absorbs and diffuses most of the light from the bulb.

In one example, the inner shade, centered preferably about 1″ inside the outer shade, could have cutouts of several small stars. The outer translucent shade, having no apertures or openings, would reflect the intense direct light from the star cutouts of the inner shade. Additionally, because of the air space that separates the two shades, the reflected stars would move and stretch on the outer shade as the perspective of the viewer changed. Other results are equally impressive.

Viewing apertures of various shapes and sizes can be added to the outer shade that would allow the viewer to see more directly glowing pictures and designs on the inner shade. The inner shade material, preferably made of paper, acetate sheets, or thin printable plastic, would optimize the diffusion of light from the light bulb and help define and clarify the desired images.

One unexpected result of the dual shade system is the ability to create motion. By mounting a small motor in the base of the lamp one can, by gear or belt drive, turn a hollow vertical shaft around, and supported by the typical hollow rod that supplies the electrical cord to the socket. On the upper end of the rotating shaft, located just under the socket, a removable collar or flanged attachment point can support a series of arms or supports for creating motion. While there may be several motion effects possible using this system, two examples are given hereafter mentioned. First, fixing the outer shade to the bulb frame in typical fashion, and turning the entire inner shade connected by equally spaced support arms from the upper end of the rotating shaft. Thus, with appropriately spaced viewing apertures on the outer shade, a series of images on the inner rotating shade could, for instance, display educational pictures such as ABC'S or basic tools such as a hammer, saw, and drill. as they pass through the outer shade's viewing aperture. Secondly, a small wire or pre-shaped plastic arm can extend from the collar on the upper end of the rotating shaft, just under the socket, and up into the air space on the bottom edge of, and between, the two shades. Small images that compliment motion such as cars, sports figures or other desired caricatures can be attached to the thin wire or plastic arm and rotate 360 degrees in between the shades and, consequently, move in and through the outer shades' viewing aperture.

The method of attaching the two lampshades can vary as they may be fixed together as one unit or the they may be connected to each other by some form of hanger system in which, but not limited to, the outer shade has a series of small bracket like arms which extend from the upper or lower edge and connect to the upper or lower edge of the inside shade.

The preferred design creates a depth effect in which the outer shade has one or more viewing apertures or windows, sized appropriately on the shade, which allows the viewer to look through the window to an image on the interior shade an inch or so inside. The depth of the air space can vary and compliment any overall desired effect. Using this basic example, two preferable vantage points become evident: the perspective of being inside looking outside, at snowmen in a front yard for example, or the perspective of being outside looking in at a scene or image inside a home or business that would be highlighted. This design allows for a variety of images and settings in which the framed, focused use of an aperture in the shape of a window is incorporated into the unique lighted format of a lamp and lampshade. This depth effect created with two shades is not limited to the use of the square or rectangular shaped window but can have varying shapes and sizes, which can be used in a wide variety of images and visual effects. Another effect is created by cutting out the outline of letters to form words on the outer shade which would then glow from the light of the diffused inner shade.

For example, the outer shade could be a forest or a cloud with an opening in which one looks through to a lake with a boat or balloon floating by. One could also create a series of geometric openings in the outer shade in the shape of stars, diamonds, or hearts which would glow with the color of the interior shade as light is diffused.

Therefore, this new design in lampshades adds not only the impression of depth as you look through a window or other shape, but also allows the artist or designer to consider other important effects and illusions such as the diffusion of light through two shades. The designer has the advantage of considering combinations of materials of varying textures and colors that would be enhanced by the depth and light effect, of the use of shadows or photographs. Other inventive features can be incorporated such as adding a motor that would turn, oscillate, or create an up and down movement on the interior or exterior shade; creating primary or secondary movements inside and between the two shades such as floating balloons, or a person running; or creating several depths or levels of shades.

The invention and its embodiments will be described hereinafter in more detail by reference to the drawings.

### BRIEF DESCRIPTION OF THE DRAWINGS

In the accompanying drawings:

FIG. 1 is a front view of one embodiment of the present invention;

FIG. 2 is an exploded view of the inner and outer shades depicted in FIG. 1;

FIG. 3 is a perspective view with a cross-sectional view of another embodiment of the present invention depicting a rotating caricature between the inner and outer shades, such that the caricature is observable through an aperture in the outer shade as it rotates around the inner shade and passes by a pictorial representation on said inner shade;

FIG. 4 depicts a cross-section view of one embodiment of the present invention depicting a practical application for providing the rotating feature of the present invention;

FIG. 4a is a partial exploded cross-section view of the portion of embodiment of FIG. 4 just below the socket;

FIG. 4b is a partial exploded cross-section view of the portion of the embodiment of FIG. 4 in the base portion;

FIG. 5a is a schematic view of one application of the present invention depicting the support for a rotatable caricature;

FIG. 5b is a schematic view of one application of the present invention depicting the support for a rotatable inner shade;

FIG. 5c is a schematic view of one application of the present invention depicting the support for a rotatable outer shade; and

FIG. 5d is a schematic depiction of one typical application for making a caricature oscillate up and down as it rotates for providing special effects.

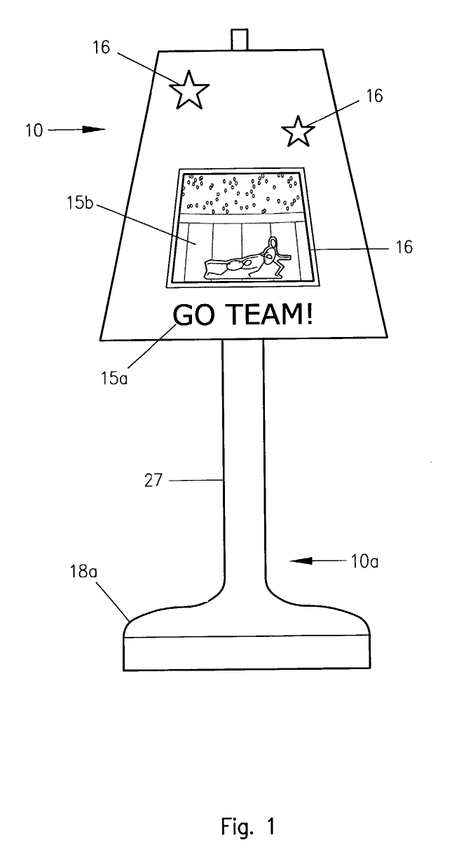

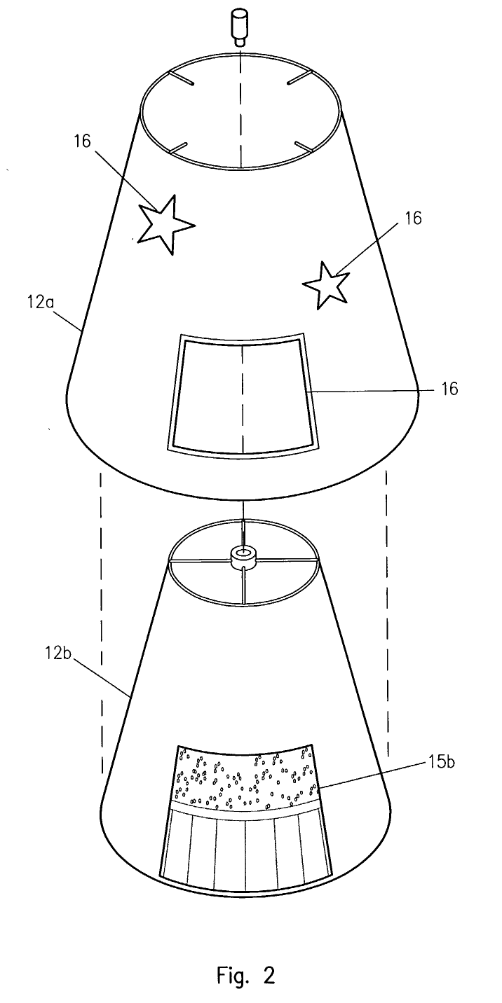

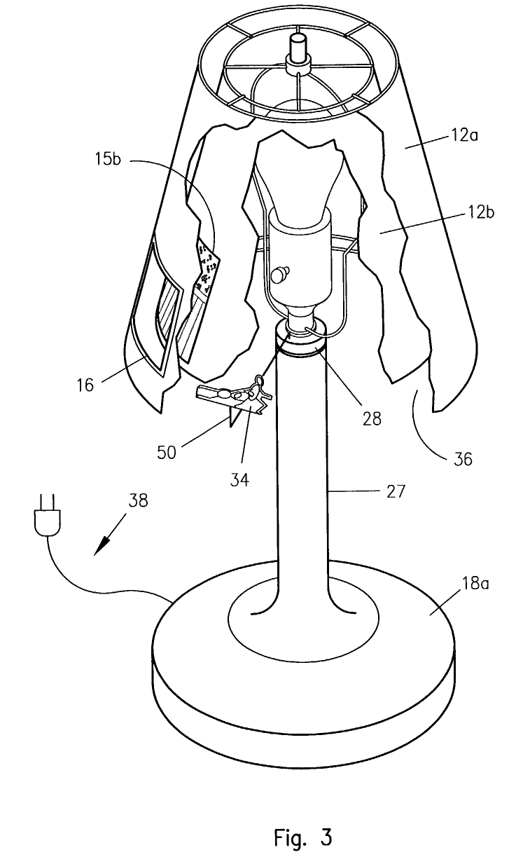

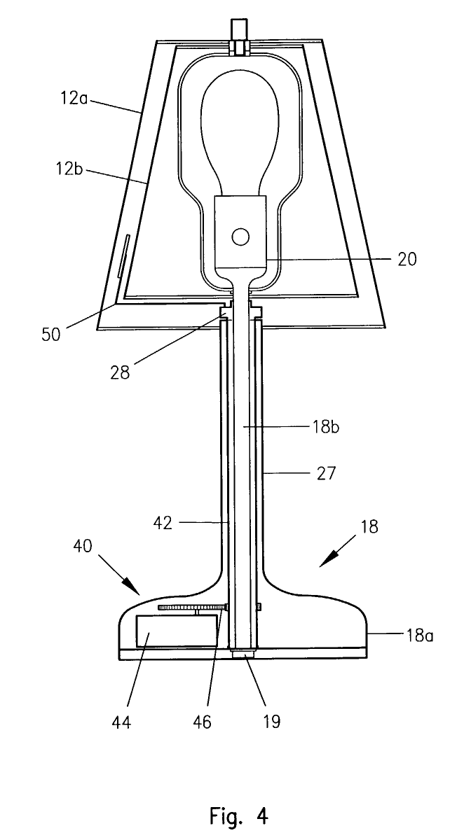

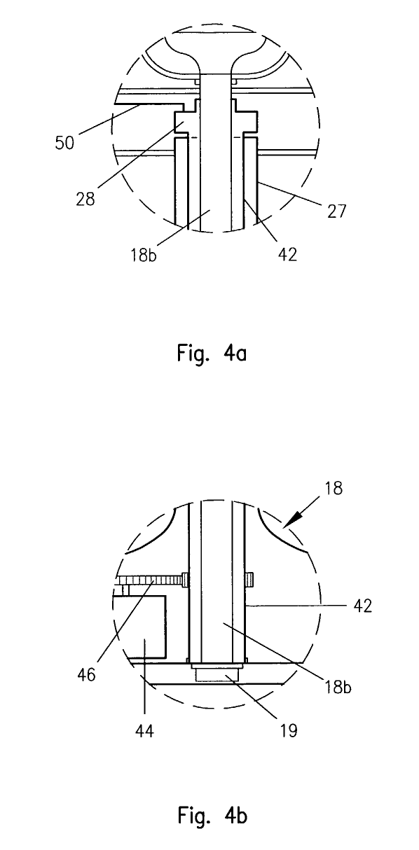

Referring now to the drawings, FIGS. 1-4, including FIGS. 4a and 4b, discloses alternative embodiments of the present invention, which is a dual lampshade system, and is depicted generally as 10. The invention, which is a decorative display device 10 is depicted and includes a lamp 10a having a base portion 18, which is made up of a horizontal portion 18a and a vertical member 18b typically attached by mounting nut 19. The vertical member extends from the horizontal portion 18a of the base portion 18 to a light bulb socket 20 in which a light bulb is inserted for illumination.

Means 38 for electrically energizing the lamp is provided. This can be typically done by running an electrical wire through a hollow center of vertical member 18b so as to be in contact with the socket 20 and the wire's other end connected to a plug coming out of the base portion 18 of the lamp 10a for insertion into a 110 v AC current electrical outlet. Another method is by insertion of a DC power circuit in an appropriate location within the lamp 10a, when it is preferred to have a bulb and bulb socket designed to be used in a DC circuit. It is a matter of design choice. In either case, a standard switch turns the light on or off. In addition, as will be discussed in more detail below, the same electrical circuitry can be connected so as to energize and operate the rotational and oscillating features of the device 10.

A pair of concentric lampshades surround the light bulb. The outer and inner lampshades, 12a and 12b respectively, are configured so as to create a continuous airspace or spacing 36 between the outer and inner lampshades 12a,12b. In one embodiment, the outer and inner lampshades 12a,12b are symmetrically shaped to be of similar configuration so as to maintain a uniform spacing 36 between the outer and inner lampshades 12a,12b.

The outer lampshade 12a has one or more viewing apertures or openings 16 at predetermined locations. The apertures 16 can be shaped to accommodate any desired theme or design such as to form a window of a house depicted on the outer lampshade 12a or to form cut out stars to indicate night starlight themes.

As noted above, the outer lampshade 12a can have pictorial representations 15a representing a predetermined theme. These can be in the form of color foreground, pictures, images, words and text, printed caricatures, etc. Similarly, the inner lampshade 12b can have one or more pictorial representations 15b at predetermined locations. The inner lampshade pictorial representations 15b are located so as to be viewable through the one of more apertures 16 in the outer lampshade 12a. Again these pictorial representations 15b on the inner lampshade 12b can be in the form of color background, pictures, images, printed caricatures, etc., whatever is desired to express a specific theme or desired artistic effect. Seasonal themes, holiday themes, sport themes, children play themes, special event themes, etc., are contemplated to be very marketable themes for incorporation in the device 10.

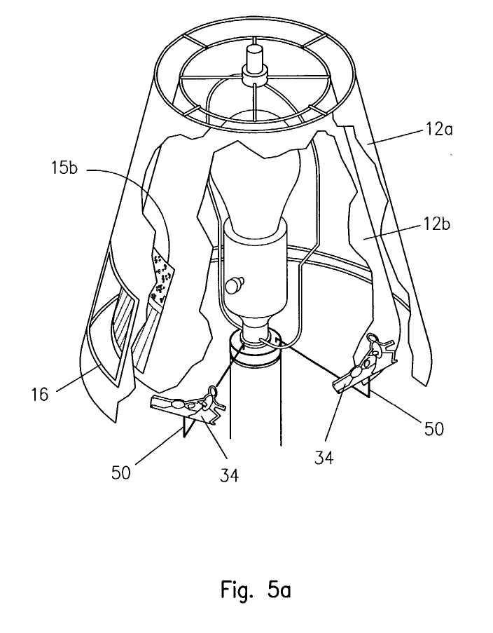

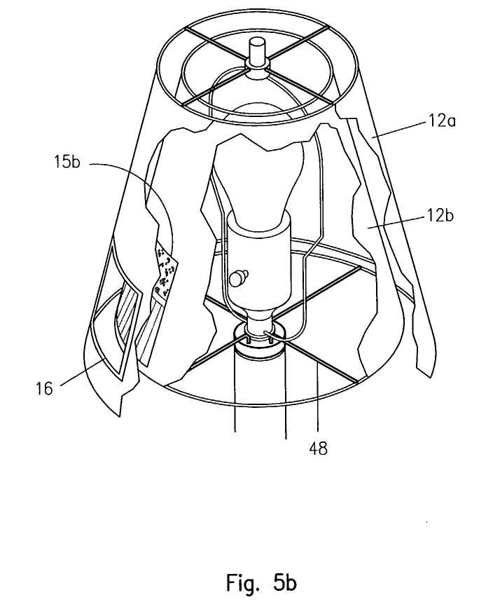

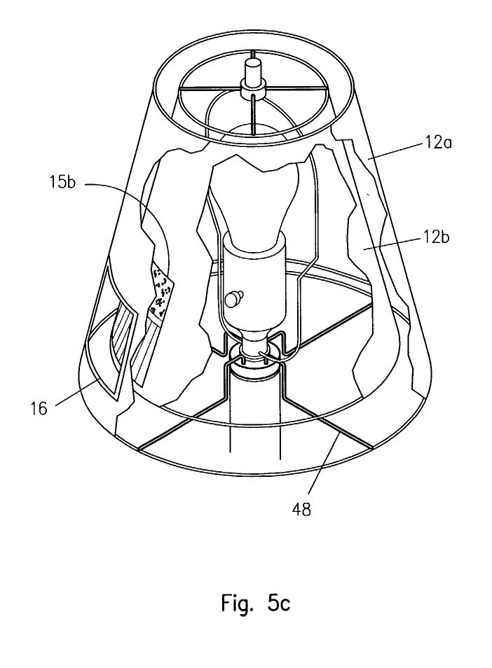

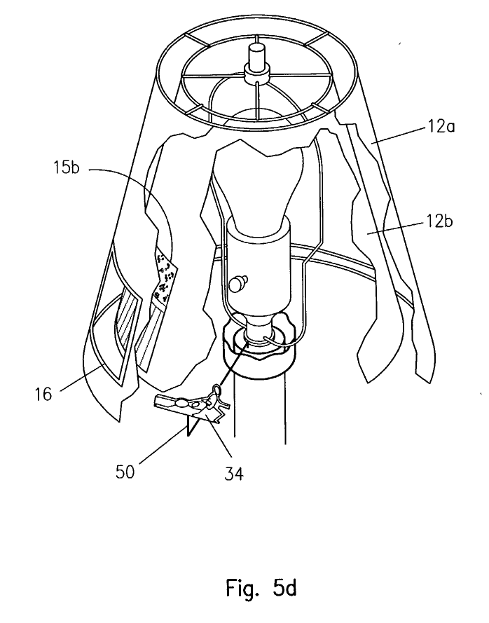

In order to enhance the appeal to the device 10 and to dynamically express and depict the desired theme, the device 10 further includes means 40 for rotating one of the outer and inner lampshades 12a, 12b relative to the other. Means 40 can also include a plurality of support arms 48 radially extending from a rotatable collar or attachment point 28 around the vertical member 18b of the lamp base portion 18 near the light bulb socket 20 to the one of the outer and inner lampshades 12a,12b. As shown in FIGS. 5b and 5c conceptually, supports 48 can simply be connected to either shade desired to be rotated, such as to the base frame of the shade itself. Typically, this is simply wire attached to the frame wire of the shade. Means 40 can be electrically energized using the same circuitry to energize the lamp itself as described above, including the option to selectively operate just the bulb or to operate both the bulb and the rotation of the shades. As shown in FIG. 4 conceptually, a rotatable shaft or hollow tube 42 concentrically overlaying the vertical member 18b can be rotated using an electric motor 44 in mechanical communication with the hollow tube 42. For example, a gear type or belt type drive mechanism 46 may be used to rotate the hollow tube 42. In addition, the support arms 48 may also be simultaneously rotated as the hollow tube 42 rotates.

Means 40 can also serve as means for rotating one or more caricatures 34 in between the outer and inner lampshades 12a,12b. In this case, supports arms 50 connected to collar 28 and rotating hollow shaft 42, as shown conceptually in FIG. 5a, hold a caricature or figurine 34 at the end of the support arm 50 such that the caricature 34 is located in the airspace 36 and can freely rotate in between the lampshades 12a,12b so that the caricatures 34 can be viewed as they pass by the apertures 16 in the outer shade 12a. For example, the caricature 34 can be a reindeer or sleigh passing by or a football player trying to tackle another player. The caricatures 34 represent a predetermined theme.

The means for rotating the one or more caricatures 34 in between lampshades 12a,12b can further be modified for oscillating the one or more caricatures 34 up and down as the one or more caricatures 34 rotate between the lampshades 12a,12b. To accomplish this, one preferred method is as shown conceptually in FIG. 5d where the support arm 50 rides on a scalloped rim bent or shaped with measured, predetermined curves, supported from the top end shaft cover 27 that surround the rotating shaft 42, just under the attachment point or collar 28 that supports supports arm 50. For example, this feature could be used to show a sleigh and reindeer climbing off a roof or landing on a roof or passing by some stars, or it could be used to show an athlete jumping toward a basket.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

I claim:

1. A decorative display device comprising:
a lamp having a base portion, the base portion further including a horizontal portion and a vertical member extending from the horizontal portion of the base portion to a light bulb socket, the light bulb socket for receiving a light bulb;
means for electrically energizing the lamp; and
a pair of concentric lampshades surrounding the light bulb, the pair of concentric lampshades comprising an outer and an inner lampshade and configured so as to create a continuous airspace between the inner and outer lampshades.

2. The device according to claim 1, wherein the outer and inner lampshades are symmetrically shaped to be of similar configuration so as to maintain a uniform spacing between the inner and outer lampshades.

3. The device according to claim 1, wherein the outer lampshade has one or more apertures at predetermined locations, the apertures being shaped for a desired design.

4. The device according to claim 3, wherein the outer lampshade has pictorial representation representing a predetermined theme.

5. The device according to claim 3, wherein the inner lampshade has one or more pictorial representations at predetermined locations, the inner lampshade pictorial representations being located so as to be viewable through the one of more apertures in the outer lampshade.

6. The device according to claim 1, further comprising:
means for rotating one of the inner and outer lampshades relative to the other.

7. The device according to claim 6, wherein the means for rotating one of the inner and outer lampshades relative to the other further comprises:
a plurality of support arms radially extending from a location near the light bulb socket to the one of the inner and outer lampshades.

8. The device according to claim 6, wherein the means for rotating one of the inner and outer lampshades relative to the other includes an electric motor in mechanical communication with a hollow tube rotatably mounted over said vertical member.

9. The device according to claim 1, further comprising:
means for rotating one or more caricatures in between the inner and outer lamp shades.

10. The device according to claim 9, wherein the outer lampshade has one or more apertures at predetermined locations, the apertures being shaped for a desired design.

11. The device according to claim 10, wherein the outer lampshade has one or more pictorial representations representing a predetermined theme.

12. The device according to claim 10, wherein the inner lampshade has one or more pictorial representations at predetermined locations, the inner lampshade pictorial representations being located so as to be viewable through the one of more apertures in the outer lampshade.

13. The device according to claim 12, wherein the means for rotating the one or more caricatures in between the inner and outer lampshades further comprises:
a plurality of support arms radially extending from location near the light bulb socket to the one or more caricatures.

14. The device according to claim 9, wherein the means for rotating the one or more caricatures includes an electric motor in mechanical communication with a hollow tube rotatably mounted over said vertical member.

15. The device according to claim 13, wherein the one or more caricatures are located so as to be viewable through the one or more apertures in the outer lampshade when rotating by said one or more apertures.

16. The device according to claim 15, wherein the outer lampshade has one or more pictorial representation representing a predetermined theme.

17. The device according to claim 15, wherein the one or more pictorial representations on the inner and outer lampshades and the one or more caricatures represent a predetermined theme.

18. The device according to claim 16, wherein the one or more pictorial representations on the inner and outer lampshades and the one or more caricatures represent a predetermined theme.

19. The device according to claim 13, wherein the means for rotating the one or more caricatures in between the inner and outer lampshades further comprises:
means for oscillating the one or more caricatures up and down as the one or more caricatures rotate between the inner and outer lampshades.

20. The device according to claim 7, wherein the means for rotating the one or more caricatures in between the inner and outer lampshades further comprises:
means for oscillating the one or more caricatures up and down as the one or more caricatures rotate between the inner and outer lampshades.
